(19) United States
(12) Patent Application Publication
(10) Pub. No.: US 2001/0033492 A1
(43) Pub. Date: Oct. 25, 2001

(54) ILLUMINATED DIAGNOSABLE BUCKLE ASSEMBLY

(76) Inventors: LLOYD WALKER ROGERS, SHELBY TOWNSHIP, MI (US); KENNETH JOHN SIEGFRIED, CLARKSTON, MI (US); LON A OFFENBACHER, ROCHESTER, MI (US)

Correspondence Address: KATHRYN A MARRA, DELPHI TECHNOLOGIES INCORPORATED, LEGAL STAFF, P O BOX 5052, TROY, MI, 480075052

(21) Appl. No.: 09/363,065

(22) Filed: Oct. 4, 1999

(51) Int. Cl. B60Q 1/00

(52) U.S. Cl. 362/483

(57) ABSTRACT

An illuminated diagnosable buckle assembly for a seat restraint system in a vehicle includes a housing and a buckle disposed in the housing and operatively connected to vehicle structure for receiving a latch plate. The illuminated diagnosable buckle assembly also includes a switch disposed in the housing and cooperable with the latch plate to indicate an unbuckled and buckled position. The illuminated diagnosable buckle assembly further includes an illuminator connected to the switch for illumination when the switch is either one of the unbuckled or buckled positions.

### TECHNICAL FIELD

The present invention relates generally to seat restraint systems for vehicles and, more particularly, to an illuminated diagnosable buckle assembly for a seat restraint system in a vehicle.

### BACKGROUND OF THE INVENTION

It is known to provide a seat restraint system such as a seat belt in a vehicle to restrain an occupant in a seat of the vehicle. In some vehicles, the seat restraint system may be a lap belt, a shoulder belt or both. Typically, the lap belt and shoulder belt are connected together at one end. The seat restraint system includes a latch plate at the connected end. The seat restraint system also includes a buckle connected at one end by webbing or the like to vehicle structure. The buckle receives the latch plate to be buckled together. When the buckle and latch plate are buckled together, the seat restraint system restrains movement of the occupant to help protect the occupant during a collision.

It is desirable to provide a diagnosable buckle for a seat restraint system in a vehicle. It is also desirable to provide an illuminated buckle for a seat restraint system in a vehicle. It is further desirable to provide an illuminated diagnosable buckle for a seat restraint system in a vehicle.

### SUMMARY OF THE INVENTION

It is, therefore, one object of the present invention to provide a diagnosable buckle for a seat restraint system in a vehicle.

It is another object of the present invention to provide an illuminated buckle for a seat restraint system in a vehicle.

It is yet another object to provide an illuminated diagnosable buckle for a seat restraint system in a vehicle.

To achieve the foregoing objects, the present invention is an illuminated diagnosable buckle assembly for a seat restraint system in a vehicle including a housing and a buckle disposed in the housing and operatively connected to vehicle structure for receiving a latch plate. The illuminated diagnosable buckle assembly also includes a switch disposed in the housing and cooperable with the latch plate to indicate an unbuckled and buckled position. The illuminated diagnosable buckle assembly further includes an illuminator connected to the switch for illumination when the switch is in either one of the unbuckled and buckled positions.

One advantage of the present invention is that an illuminated diagnosable buckle assembly is provided for a seat restraint system in a vehicle. Another advantage of the present invention is that the illuminated diagnosable buckle assembly combines the features of a diagnosable switch with buckle illumination for a seat restraint system in a vehicle. Yet another advantage of the present invention is that the illuminated diagnosable buckle switch increases reliability of a buckle usage signal for the seat restraint system in a vehicle. Still another advantage of the present invention is that the illuminated diagnosable buckle assembly reduces the number of parts required for separate diagnosable switches and illuminated switches.

Other objects, features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a front elevational view of an illuminated diagnosable buckle assembly, according to the present invention, illustrated in operational relationship with a seat restraint system of a vehicle.

FIG. 2 is a fragmentary plan view of the illuminated diagnosable buckle assembly of FIG. 1 illustrating an unbuckled position.

FIG. 3 is a view similar to FIG. 2 illustrating the illuminated diagnosable buckle assembly in a buckled position.

FIG. 4 is a schematic view of a circuit for the illuminated diagnosable buckle assembly of FIG. 1.

FIG. 5 is a schematic view of another embodiment, according to the present invention, of the circuit of FIG. 4 for the illuminated diagnosable buckle assembly of FIG. 1.

### DESCRIPTION OF THE PREFERRED EMBODIMENT

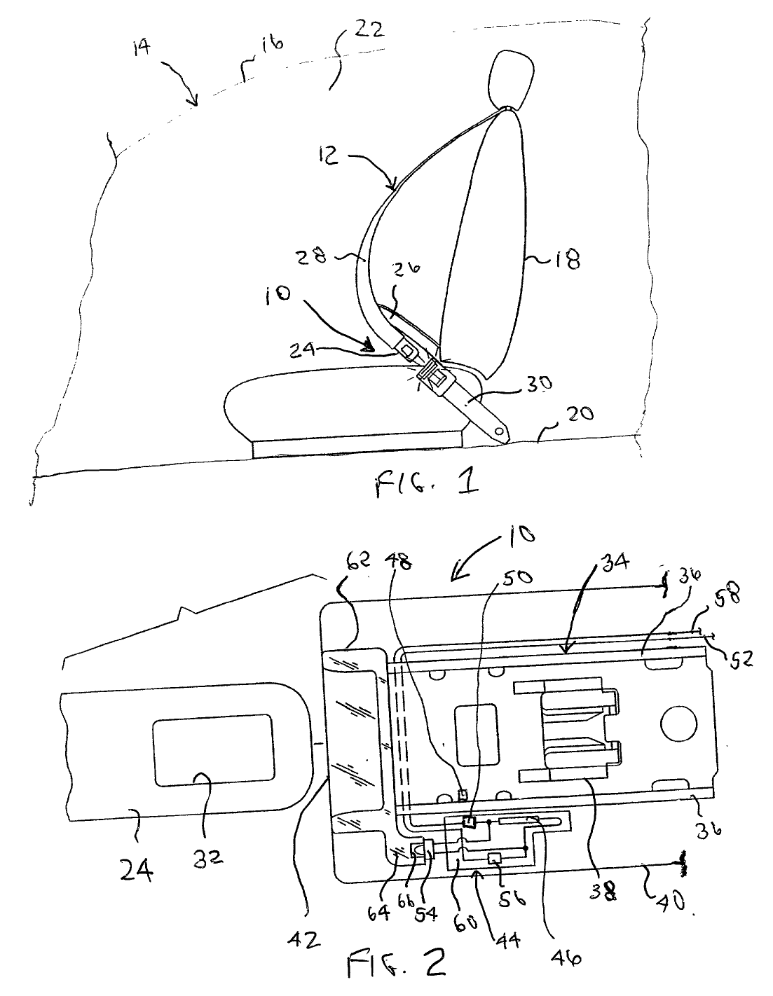

Referring to the drawings and in particular FIGS. 1 and 2, one embodiment of an illuminated diagnosable buckle assembly 10, according to the present invention, is shown for a seat restraint system, generally indicated at 12, in a vehicle (partially shown), generally indicated at 14. The vehicle 14 includes a vehicle body 16 and a seat 18 mounted by suitable means to vehicle structure 20 such as a floorpan in an occupant compartment 22 of the vehicle body 16. In this embodiment, the seat 18 is a front seat of the vehicle 14. It should be appreciated that the seat 18 could be a rear, second row or third row seat for the vehicle 14.

Referring to FIGS. 1 and 2, the vehicle 14 includes the seat restraint system 12 for restraining an occupant (not shown) in the seat 18. The seat restraint system 12 includes a latch tongue or plate 24 connected to an end of either one of a lap belt 26, shoulder belt 28, or both which have another end connected to a retractor (not shown). The seat restraint system 12 also includes the illuminated diagnosable buckle assembly 10 connected by suitable means such as belt webbing 30 to the vehicle structure 20. The latch plate 24 has an aperture 32 extending therethrough and is engageable and disengageable with the illuminated diagnosable buckle assembly 10 as illustrated in FIGS. 2 and 3. It should be appreciated that, except for the illuminated diagnosable buckle assembly 10, the seat restraint system 12 and vehicle 14 are conventional and known in the art.

Referring to FIGS. 1 through 3, the illuminated diagnosable buckle assembly 10, according to the present invention, includes a buckle, generally indicated at 34, for receiving the latch plate 24 to engage and disengage the latch plate 24. The buckle 34 has a pair of side plates 36 extending longitudinally and a locking member 38 pivotally connected between the side plates 36. The locking member 38 pivots between a latched or unbuckled position of FIG. 2 in which an integral dependent lock bar (not shown) engages or is disposed in the aperture 32 of the latch plate 24 and an unlatched or unbuckled position of FIG. 1 in which the lock bar is raised above or disengages the aperture 32 in the latch plate 34. The buckle 34 is of the type disclosed in U.S. Pat. No. 4,899,424 to Barnes et al., the disclosure of which is hereby incorporated by reference. It should be appreciated that the buckle 34 is conventional and known in the art.

The illuminated diagnosable buckle assembly 10 also includes a housing 40 disposed about and enclosing the buckle 34. The housing 40 has an aperture 42 at a forward end to receive the latch plate 24 and an opposite rearward end attached to the belt webbing 30. The housing 40 is generally rectangular in shape and made of a rigid material such as plastic. It should be appreciated that only one half of the housing 40 is illustrated in FIGS. 2 and 3.

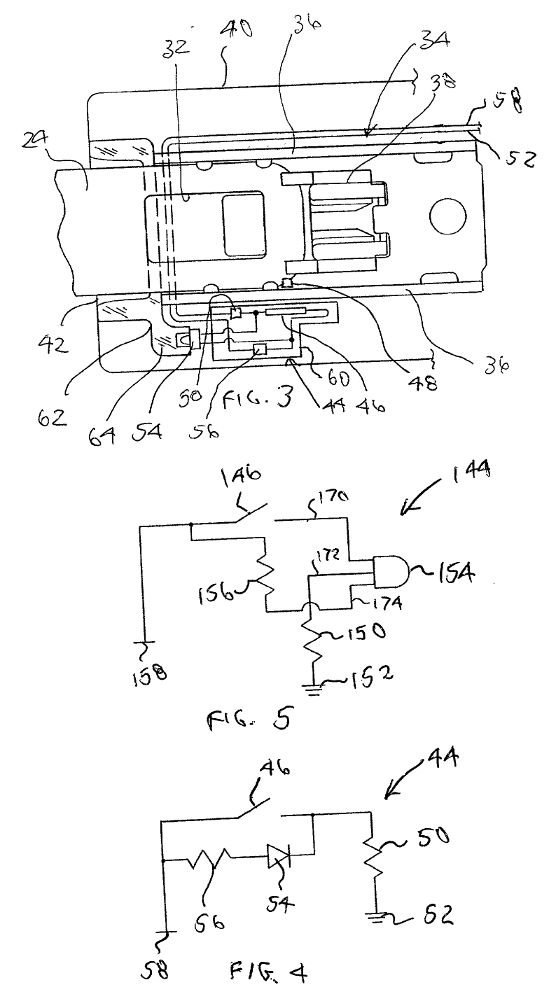

Referring to FIGS. 2 through 4, the illuminated diagnosable buckle assembly 10 includes an electrical circuit, generally indicated at 44, for diagnosing and illuminating usage of the seat restraint system 12. The circuit 44 includes a switch 46 for cooperating with the latch plate 24. The switch 46 is diagnosable and has two positions. Preferably, the switch 46 is of a magnetic reed type that is actuated by a magnet 48 mounted on the buckle 34 by suitable means such as a movable blade or slide (not shown). The magnet 48 and slide-will translate longitudinally when the latch plate 24 is inserted into the housing 40 and engages the slide. The latch plate 24 moves the magnet 48 from an open or first position with the switch 46 illustrated in FIG. 2 to a closed or second position illustrated in FIG. 3. It should be appreciated that the position of the magnet 48 relative to the switch 46 changes the state of the switch 46, giving a different output current from the switch 46. It should also be appreciated that the slide is preloaded by a spring (not shown) to return the slide and magnet to the first position when the latch plate 24 is removed from the housing 40.

The circuit 44 also includes a first resistor 50 interconnecting one end of the switch 46 and ground 52. The first resistor 50 has a predetermined value such as one hundred ohms (100 Ω). The circuit 44 includes an illuminator 54 connected in parallel with the switch 46 with one end interconnecting the switch 46 and the first resistor 50. The illuminator 54 is a light emitting diode that is illuminated when the switch 46 is in the open position. The circuit 44 also includes a second resistor 56 having one end connected to the other end of the illuminator 54 and another end connected to a source of power 58 such as a controller (not shown) of the vehicle 14. The second resistor 56 has a predetermined value such as three hundred ohms (300 Ω). The circuit 44 is mounted on a circuit board 60 connected to the housing 40 and is potted and connected by electrical leads or wires to the source of power 58 and ground 52.

The illuminated diagnosable buckle assembly 10 further includes a light pipe 62 to transmit light emitted by the illuminator 54 to an upper surface or forward end of the housing 40. The light pipe 62 has a general “U” shape with a flange 64 extending laterally and longitudinally and including a recess 66 to receive a portion of the illuminator 54. The light pipe 62 is made of a translucent material such as plastic for being illuminated by the light emitted from the illuminator 54.

In operation, the illuminated diagnosable buckle assembly 10 is illustrated in an unlatched or unbuckled state in which the latch plate 24 removed from the housing 40. In this state, the illuminated diagnosable buckle assembly 10 is illuminated when the vehicle 14 is “woken up” by a door (not shown) on the vehicle 12 being opened. Current from the source of power 58 flows through the second resistor 56, illuminator 54 and first resistor 50 to ground 52. The flow of current through the illuminator 54 causes the illuminator to illuminate and emit light in the recess 66 of the light pipe 62. The emitted light travels through the entire light pipe 62 and is illuminated. The illuminated light pipe 62 illuminates an external portion, such as an upper surface or forward end, of the housing 40 and visually indicates to an operator of the vehicle 14 that the seat restraint system 12 is in an unbuckled state. It should be appreciated that the illuminated diagnosable buckle assembly 10 turns ON when unbuckled and turns OFF when buckled.

When unbuckled, the magnet 48 and switch 46 are in the first position. The controller receives a signal from the switch 48 of a first predetermined value to determine that the seat restraint system 12 is unbuckled. Also, if the controller receives no signal from the switch 46, the controller determines that there is an unplugged wiring connector (not shown) to the seat restraint system 12. Further, if the controller receives a signal from the switch 46 approximately equal to the current from the source of power 58, the controller determines that there is a shorted wiring connector to the seat restraint system 12.

Referring to FIG. 3, the latch plate 24 is disposed through the aperture 42 in the open end of the housing 40 and engages the slide to move the magnet 48 to the second position relative to the switch 46. The latch plate 24 engages the locking member 38 in the latched or buckled state. In this state, current from the source of power 58 flows through the switch 46 and first resistor 50 to ground. As a result, the illuminator 54 receives no current and does not emit light. The controller receives a signal from the switch 46 of a second predetermined value which is greater than the first predetermined value but less than the current from the source of power 58 to determine that the seat restraint system 12 is buckled. It should be appreciated that the circuit 44 could be configured such that the illuminator 54 illuminates light when the latch plate 24 is buckled.

Referring to FIG. 5, another embodiment 144, according to the present invention, of the circuit 44 is shown. Like parts of the circuit 44 have like reference numerals indicated by one hundred (100). The circuit 144 includes the illuminator 154 being a bicolor diode that changes color based on the current flowing therethrough. The illuminator 154 has a first lead 170 connected to the switch 146, a second lead 172 connected to the first resistor 150 and a third lead 174 connected to the second resistor 156.

In operation of the circuit 144, the illuminator 154 emits a first colored light when current flows from the source of power 158 through the second resistor 156, illuminator 154 and second resistor 150 to ground 152. The illuminator 154 emits a second colored light when current flows from the source of power 158 through the switch 146, illuminator 154 and second resistor 150 to ground 152. It should be appreciated that the first and second colored light visually indicates to the operator of the vehicle that the seat restraint system 12 is either buckled or unbuckled.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. An illuminated diagnosable buckle assembly for a seat restraint system in a vehicle comprising:
a housing;
a buckle disposed in said housing and operatively connected to vehicle structure for receiving a latch plate;
a switch disposed in said housing and cooperable with the latch plate to indicate an unbuckled and buckled position; and
an illuminator connected to said switch for illumination when said switch is in either one of the buckled and unbuckled positions.

2. An illuminated diagnosable buckle assembly as set forth in claim 1 wherein said switch comprises a magnetic reed switch.

3. An illuminated diagnosable buckle assembly as set forth in claim 1 wherein said illuminator is a light emitting diode.

4. An illuminated diagnosable buckle assembly as set forth in claim 3 wherein said light emitting diode emits a plurality of colors.

5. An illuminated diagnosable buckle assembly as set forth in claim 1 including a resistor interconnecting said illuminator and a source of power.

6. An illuminated diagnosable buckle assembly as set forth in claim 1 including a resistor interconnecting said switch and ground.

7. An illuminated diagnosable buckle assembly as set forth in claim 1 including a light pipe disposed partially in said housing and adjacent said illuminator to transmit light emitted by said illuminator to an external portion of said housing.

8. An illuminated diagnosable buckle assembly as set forth in claim 7 wherein said light pipe includes a recess, said illuminator being at least partially disposed in said recess.

9. An illuminated diagnosable buckle assembly as set forth in claim 1 including a movable magnet cooperating with said switch and the latch plate.

10. An illuminated diagnosable buckle assembly as set forth in claim 1 including a circuit board disposed in said housings said switch being mounted to said circuit board.

11. An illuminated diagnosable buckle assembly as set forth in claim 1 wherein said buckle includes a locking member engagable and disengagable with the latch plate.

12. An illuminated diagnosable buckle assembly for a seat restraint system in a vehicle comprising:
a housing;
a buckle disposed in said housing and operatively connected to vehicle structure for receiving a latch plate;
a switch disposed in said housing and cooperable with the latch plate to indicate a first position and a second position;
an illuminator connected to said switch for illumination when said switch is in either one of the first position and the second position; and
a light pipe disposed partially in said housing and adjacent said illuminator to transmit light emitted by said illuminator to an external portion of said housing.

13. An illuminated diagnosable buckle assembly as set forth in claim 12 wherein said switch comprises a magnetic reed switch.

14. An illuminated diagnosable buckle assembly as set forth in claim 12 wherein said illuminator is a light emitting diode.

15. An illuminated diagnosable buckle assembly as set forth in claim 14 wherein said light emitting diode emits a plurality of colors.

16. An illuminated diagnosable buckle assembly as set forth in claim 12 including a first resistor interconnecting said illuminator and a source of power.

17. An illuminated diagnosable buckle assembly as set forth in claim 16 including a second resistor interconnecting said switch and ground.

18. An illuminated diagnosable buckle assembly as set forth in claim 12 wherein said buckle includes a movable magnet cooperating with said switch and the latch plate.

19. An illuminated diagnosable buckle assembly as set forth in claim 18 including a circuit board disposed in said housing, said switch being mounted to said circuit board.

20. A seat restraint system for a vehicle comprising:
a housing;
a buckle disposed in said housing and operatively connected to vehicle structure for receiving a latch plate;
a magnetic reed switch disposed in said housing;
a movable magnet disposed adjacent said buckle and cooperating with said switch and the latch plate to indicate a first position and a second position;
an illuminator connected to said switch for illumination when said switch is in either one of the first position and the second position; and
a light pipe disposed partially in said housing and adjacent said illuminator to transmit light emitted by said illuminator externally of said housing.
